(19) United States
(12) Patent Application Publication
(10) Pub. No.: US 2006/0161910 A1
(43) Pub. Date: Jul. 20, 2006

(54) Method, system and program product for automatically ensuring compatability of a code module loaded into a program-code environment

(75) Inventors: Roger E. Bonsteel, Kingston, NY (US); Juliet C. Candee, Brewster, NY (US); John L. Czukkermann, Lagrangeville, NY (US); David B. Emmes, Wappingers Falls, NY (US); Steven J. Greenspan, Poughkeepsie, NY (US); Joshua W. Knight, Mohegan Lake, NY (US); Alan M. Webb, Ridgefield, CT (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 11/035,538

(22) Filed: Jan. 14, 2005

(51) Int. Cl. G06F 9/44

(52) U.S. Cl. 717/170

(57) ABSTRACT

An approach for automatically ensuring compatibility of a requested code module for a program-code environment is provided in which the requested code module provides an indication of at least one compatible operating system version which can execute the requested code module. This indication is automatically compared to version information of a currently-running operating system of the program-code environment when the currently-running operating system loads the requested code module. Compatibility of the requested code module is ensured upon the automatic comparison establishing agreement between the indication and the version information of the currently-running operating system. In another aspect, when the requested code module is to be loaded in response to a request to access the requested code module, a code-module version requirement of a requesting code module is automatically compared to version information of the requested code module to ensure compatibility of the requested code module.

### TECHNICAL FIELD

This invention relates in general to ensuring compatibility of a code module in a program-code environment and, more particularly, to a technique for automatically ensuring compatibility of a code module and a program-code environment at load time.

### BACKGROUND OF THE INVENTION

The operating system of a computing environment provides a program-code environment in which code modules will execute. The operating system defines the rules to which these code modules must conform in order for the code modules to execute properly within the program-code environment. These rules are manifested in the operating system documentation and the operating system header files. The operating system documentation explains the obligations of the code-module writer. The operating system header files, which are provided by the operating system and incorporated by other code modules during compilation, provide information about the program-code environment (e.g., constants) and mechanisms to simplify participation in that environment (e.g., macros). The operating system header files are supplied with the operating system code.

In a program-code environment in which executable components may be loaded dynamically, it is possible that individual components may be mutually incompatible with one another or with the program-code environment itself. Existing solutions to this problem include the following: shared library environments such as UNIX or Linux which require that code modules be named in a manner which assists users in making appropriate selections. This approach has the disadvantages of limited flexibility and susceptibility to circumvention. Also, shared library environments exist which provide no verification that a given shared library is the library version expected by a dependent program. In addition, shared library environments provide no mechanism for a shared library to indicate the operating system version with which it is intended to operate. Also, version checking in an object-oriented environment such as Java does not provide a mechanism to ensure that loaded classes are themselves mutually compatible. Failing to ensure version compatibility among concurrently-loaded code modules may lead to errors during execution. Therefore, there exists a need for a technique of ensuring compatibility of a code module with an operating system of a program-code environment and compatibility among code modules in a program-code environment.

### SUMMARY OF THE INVENTION

The shortcomings of the prior art are overcome and additional advantages are provided through the provision of a method of automatically ensuring compatibility of a requested code module for a program-code environment. In accordance with an aspect of the invention, a requested code module provides an indication of at least one compatible operating system version, the requested code module being executable by the at least one compatible operating system version. The indication is automatically compared to version information of a currently-running operating system of a program-code environment when the currently-running operating system loads the requested code module. Compatibility of the requested code module is ensured upon the automatic comparison establishing agreement between the indication and the version information of the currently-running operating system.

In another aspect, the requested code module is to be loaded in the program-code environment in response to a request by a requesting code module to access the requested code module, and the method further comprises automatically comparing a code-module version requirement of the requesting code module and version information of the requested code module to ensure compatibility of the requested code module. In a further aspect, the requested code module exports a plurality of interfaces in a program communications area provided by the requested code module, and the requesting code module requests a particular interface of the plurality of interfaces exported. Accordingly, the automatic comparison of the code-module version requirement of the requesting code module and version information of the requested code module further comprises determining whether a currently-loaded version of the requested code module is capable of providing the particular interface.

Systems and computer program products corresponding to the above-summarized methods are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a flow diagram for an example of a method of introducing a requested, dynamically loadable object into a program-code environment;

FIG. 2 illustrates a flow diagram for a method of automatically ensuring compatibility of a code module for a program-code environment, in accordance with an aspect of the present invention;

FIG. 3 illustrates a flow diagram for one embodiment of a method of automatically ensuring compatibility of a requested code module loaded into a program-code environment, wherein the requested code module is loaded in response to a request to access the requested code module, in accordance with an aspect of the present invention; and

FIG. 4 illustrates a flow diagram for one embodiment of a method of automatically ensuring compatibility of a requested interface of a code module for a program-code environment, wherein another code module requests access to the requested interface, in accordance with an aspect of the present invention.

### BEST MODE FOR CARRYING OUT THE INVENTION

The present invention relates to the problem of ensuring at execution time the compatibility of a code module with the program-code environment in which the code module is loaded. The operating system or system code of a program-code environment ensures that a code module or program part conforms to the rules extant in the documentation of the program-code environment and one or more header files of the operating system. If a program part does not conform, it is not made accessible to other program parts within the program-code environment.

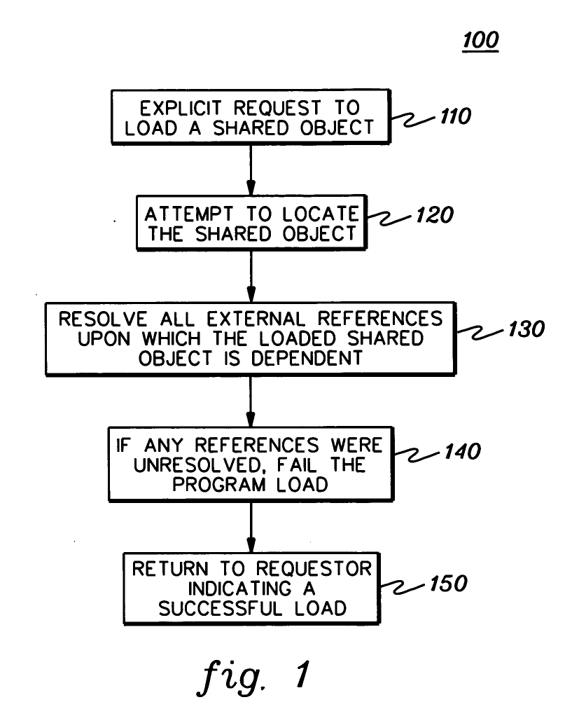

Flow diagram 100 in FIG. 1 illustrates a method of loading, validating, and introducing a requested dynamically loadable object (e.g., a shared library) into a program-code environment to make the object accessible to a requesting code module. This technique begins with an explicit request to load a shared object 110. Then the program-code environment attempts to locate the requested, shared object 120. The processing of the method shown in flow diagram 100 continues with resolving all external references upon which the requested, shared object is dependent 130. If any of these references to information exported by the operating system or other shared objects are unresolved, then the attempt to load the requested, shared object fails 140; otherwise, control returns to the requesting code module (requestor) with an indication that the requested code module was successfully loaded 150.

A program part is loaded in response to a request by another program part or as a consequence of some activity in the operating system. In either situation, there is a requester, which has an implicit obligation to supply identity and version information which collectively designate a unique instance of the required program part.

There are two distinct notions of version used herein. The first pertains to the operating system or system code itself and implies a particular specification of the operating system. This is the system version. A given version of the operating system may also be compatible with, and accept as valid, program parts that were compiled with one or more system header files for another version of the operating system. This capability is commonly known as backward compatibility. The second notion of the term version distinguishes a particular implementation of the program part being loaded. A version of a program part is only considered distinguished if its version number is unique with respect to other program part implementations. In one example, both types of version numbers are treated as natural numbers in terms of relative magnitude. This advantageously allows a range of versions to be specified in a meaningful fashion.

As used herein, an interface is considered to be an arbitrary set of information shared between compatible program parts. The version numbers of both the operating system and a compatible program part are considered to identify an interface between the system and the program part or between the program part and another program part.

The one or more system header files corresponding to an operating system or system code include a constant value indicating the version number of the operating system that the one or more system header files define. The version number, therefore, implies the capabilities of the operating system, the program-code environment, and the information and services supplied in the one or more system header files themselves. A conforming program part that includes the one or more system header files will identify the version of the operating system into which the program part can be incorporated validly.

There are two requirements for a code module or program part, which may be utilized in the present invention. A program part must include the one or more system header files provided by the operating system of the program-code environment in which the program part is to be incorporated. Also, an interface header file must be published for each interface of the program part which will be made available in the program-code environment. An interface header file defines an interface which is used by other program parts to access the program part corresponding to the interface. An interface header file must provide interface identity and interface version information needed by the operating system to validate a request for that interface. When a program part requests access to another program part's interface, the interface header file supplies the information needed to identify the requested program part's implementation and the version of the interface which the requestor will expect to use.

When a code module is being incorporated into a program-code environment, the code module must make the operating system version which the code module requires available to the currently-running operating system, which will load the code module. This may be done in several ways, and it is only required that the operating system document the mechanism chosen so that a program writer is able to ensure that the required information can be retrieved during loading. For example, a program part may make such information externally accessible, or a program part may supply the information during initialization. In embodiments for the z/OS® operating system, for example, these mechanisms correspond to declaring a data structure which includes the required information as an external symbol and returning the operating system version information as a part of a shared-data area during initialization, respectively. (The mark z/OS is a registered trademark of International Business Machines Corporation.) The key point is that the program part makes available to the currently-running operating system the version of the operating system with which the program part is expecting to run.

If the specified operating system version is compatible with the currently-running operating system (i.e., the specified operating system version is in the set of versions that the currently-running operating system supports), then the process of providing access to the loaded program part continues; otherwise, the program part is unloaded, and the process is terminated.

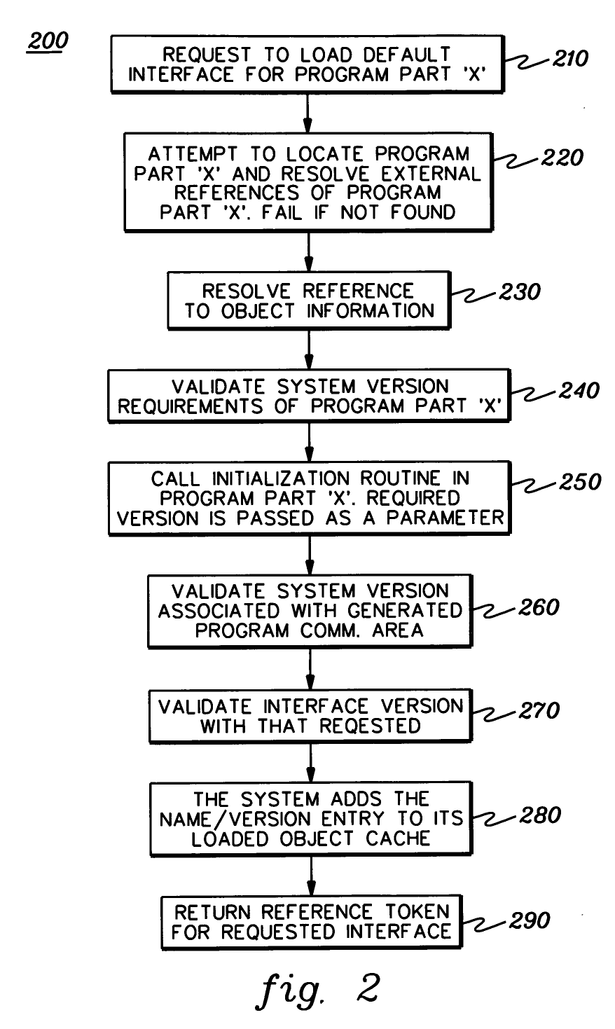

FIG. 2 illustrates flow diagram 200 for a method of automatically ensuring compatibility of a code module for a program-code environment, in accordance with an aspect of the present invention. The technique illustrated by flow diagram 200 begins with a request by a requesting code module of a program-code environment to load the default interface for a requested code module (i.e. Program Part X) 210. The program-code environment attempts to locate Program Part X 220 and indicates that the requested load operation has failed if Program Part X is not found 220. Also, the program-code environment attempts to resolve all external references upon which Program Part X depends. That is, the processing of step 220 comprises the processing of flow diagram 100 in FIG. 1. If the requested code module is found and if the external references in the requested code module are resolved, references in the requesting code module to information exported by the Program Part X object (i.e. the requested code module) are resolved 230. In accordance with an aspect of the present invention, there is only one imported reference, the address of an information block associated with the requested shared object (i.e., the requested code module). Although the structure of this information block is dependent upon the operating system or system-code version expected by the shared object, the location of system-code version information within this information block is fixed and, therefore, accessible to all versions of the system code.

If all references are resolved, the system-code version requirements of Program Part X are validated 240; that is, Program Part X's system-code version requirements and the system code's version are checked for compatibility. If the requested system-code version is greater than that of the current system code, then the access operation must necessarily fail because an earlier version of the system code has no means of anticipating how a future version might differ. If the requested code module and system code are compatible, an initialization routine in Program Part X is invoked 250. When the system code calls the initialization routine for the shared object (the requested code module), the system code passes an interface token for the system code's own services. The shared object uses this token to access system-code services. The required version of the system code's interface may be fixed, or the system code may choose to provide an interface that is compatible with the version indicated in the shared object's information block. If the requesting code module has requested a particular interface version of Program Part X, the required interface version is passed to Program Part X's initialization routine as a parameter together with the required system-code interface token 250.

Program Part X's initialization routine initializes a program communications area (PCA) that satisfies the requirements of the requesting code module (requester) and returns the PCA's address to the system code. The initialization routine of the shared object can utilize the system-code interface provided by the system code to request a different system-code interface. If the shared object's initialization routine requests a different system-code interface, the request is indicated in the PCA returned by the initialization routine to the system code. The indication in the returned PCA allows the system code to keep track of the actual dependencies upon each available system-code interface. Advantageously, this approach allows a shared object to provide an unique PCA in response to a received interface request or to return a common PCA address if that is appropriate. By invoking an initialization routine as described above, the requested code module (Program Part X) has an opportunity to condition itself in accordance with the available system-code version and the version of Program Part X requested. The program communications area resulting from the call to the requested code module's initialization routine is the only interface between the requested code module and the requestor.

The processing continues with validating the system-code version requirement associated with the program communications area (PCA) generated for the requested interface of the requested code module 260. This system-code version requirement in the PCA indicates the actual version which the requested code module's interface will be dependent upon for execution. It should be noted that the indicated system-code version requirement need not be the same as indicated previously in step 240. Also, the processing verifies that the interface version provided by the requested code module (Program Part X) is compatible with the requested interface 270. In one embodiment, the system code checks whether the range of supported interface versions indicated in the control area includes the interface version requested. The access operation fails if the interface version requested is not included in the supported interfaces indicated in the PCA. The requestor's version information is obtained from the interface header file of the requestor when the requestor is compiled.

If the interface version provided by the requested code module is compatible with the requested interface, the system code adds a name/version entry to a loaded object cache 280. Caching the entry in this way abbreviates the task of resolving subsequent requests for the requested code module. Such caching also ensures that all requestors utilize the same instance of a particular interface of the requested code module. However, a requested code module may indicate that an interface of the requested code module should not be shared in this way. If an interface of the requested code module is not to be shared, the requested code module is loaded and initialized in response to each request. The processing of FIG. 2 finishes with the system code returning a reference token for the requested interface of the requested code module to the requesting code module 290. The requesting code module can use this reference token in subsequent references to the requested interface.

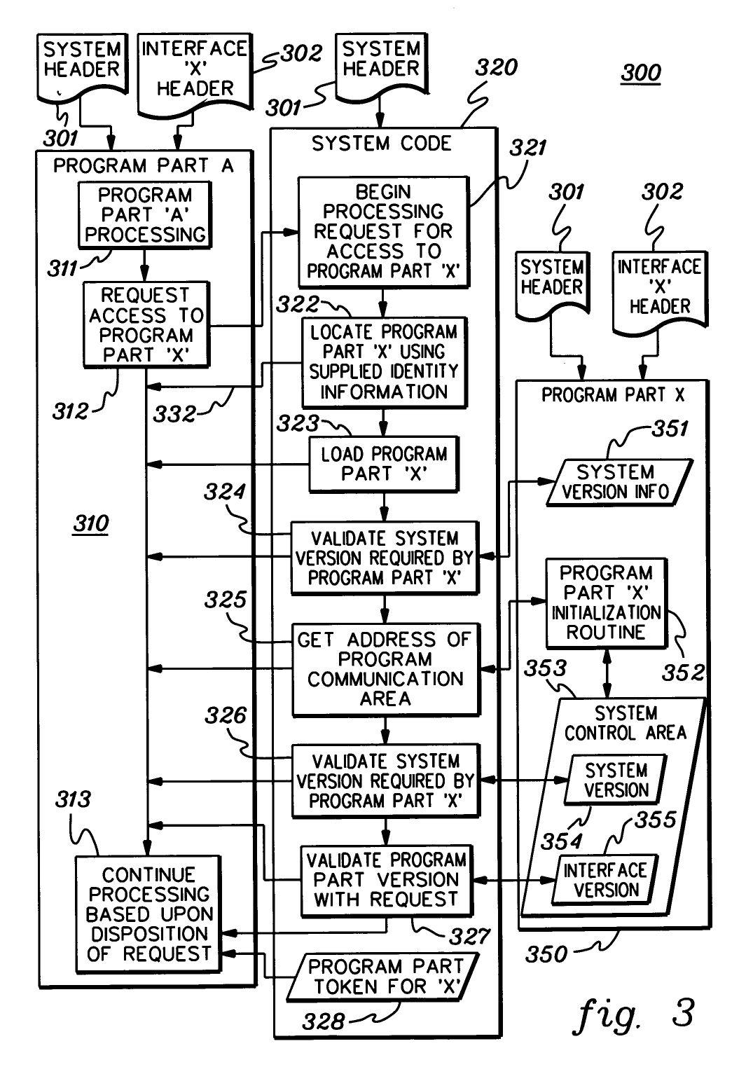

FIG. 3 illustrates flow diagram 300 for one embodiment of a method of automatically ensuring compatibility of a requested code module for a program-code environment, wherein the requested code module is loaded in response to a request to access the requested code module, in accordance with an aspect of the present invention. In this embodiment, each program part (code module) has a designated default interface. When a program part is being loaded, the default interface is implied. Consequently, a program part must provide a program communications area (PCA) corresponding to the default interface of the program part during the initialization of the program part. The program communication area includes a system control area (SCA) that can be readily located and accessed. For example, the system control area may be a prefix to the program-part-defined area of the PCA. The system code of a program-code environment will designate the way in which the SCA is to be located.

At load time, the system code locates and examines the information in the SCA. The SCA includes two sets of system-code version information upon which a corresponding interface is dependent. During the process of loading a code module and making this code module accessible to other code modules in the program-code environment, the system-code version requirement information may be re-specified by the code module to be more restrictive, but never meaningfully less restrictive, than the system-code version information already supplied (if any) to indicate one or more compatible operating system versions. Version compatibility information for an interface of a program part also includes a range of program part versions with which an interface is compliant. This provides an indication of an inclusive range of program-part versions with which a given interface is backwardly compatible. If the version supplied in the request to load the program part is in this inclusive range, then the processing of the access request to the program part continues; otherwise the processing of the access request is terminated.

If the validation of the requested program part is successful, then the system code returns a program-part token (PPTOKEN) to the requesting code module which can be used by the requesting code module to nominate the requested program part in subsequent calls.

As illustrated in FIG. 3, Program Part A 310, system code 320, and Program Part X 350 of the program-code environment are built with system header file 301. In addition, Program Part A 310, and Program Part X 350 and have access to interface header file for Program Part X 302. The processing of FIG. 3 begins with Program Part A processing 311. Then Program Part A makes a request to system code 320 to access Program Part X 312. System code 320 begins processing this request 321 by attempting to locate Program Part X using identity information supplied in the request to access Program Part X 322. If Program Part X cannot be located by system code 320, the access request fails and the processing returns to Program Part A via path 332. If Program Part X is located, system code 320 loads Program Part X into a computing system's memory 323. If Program Part X, the requested code module, cannot be loaded, the processing returns to Program Part A, the requesting code module. However, if the requested code module is loaded, system code 320 obtains system version requirement information 351 from Program Part X and validates the system version required by Program Part X 324. If Program Part X is compatible with the system code, the system code gets the address of a program communications area provided by Program Part X 325 by calling Program Part X's initialization routine 352.

Program Part X's initialization routine creates a program communications area (PCA) for a default interface of Program Part X 352. The PCA includes a system control area 353, in which Program Part X specifies system-version requirement information for compatibility with this code module and a range of versions of this code module with which the default interface is compatible. Program Part X's initialization routine returns the address of the default interface's PCA to the system code.

If the system control area of the PCA has the proper format, system code 320 validates the system code version required by the default interface of Program Part X 326 by verifying that Program Part X is compatible with the currently-running version of system code. The system-code version required by the default interface of Program Part X 354 is indicated by data provided by Program Part X in the SCA of the program communications area for the default interface. If Program Part X is compatible, the system code validates the loaded version of Program Part X with the request 327; that is, the version of the default interface 355 is compared to the version of Program Part X, which was requested by the requesting code module (Program Part A). If the default interface of the loaded version of Program Part X satisfies the request of Program Part A, the system code makes Program Part X accessible to Program Part A by returning Program Part X's program part token (PPTOKEN) to Program Part A 328. However, if any of processing steps 323 through 327 fails, Program Part X is unloaded, and the processing continues with Program Part A. When control is returned to Program Part A, Program Part A continues the processing based on the disposition of its request to access Program Part X 313.

A program module may have other interfaces, which are accessible upon request, in addition to a default interface. In order to provide access to these additional interfaces, a code module must provide a get-interface service. A requesting code module can request an additional interface of a requested code module once the requesting code module has successfully obtained access to the default interface of a requested code module; i.e., a valid PPTOKEN must be available for the requested code module.

To reference an additional interface of a code module, the requestor (requesting code module) must have included an appropriate interface header file during compilation. This header file provides appropriate interface identity and interface version information to the requester. The requestor directs the get-interface request to the system code which provides a mechanism for routing this request to the code module identified by the supplied PPTOKEN.

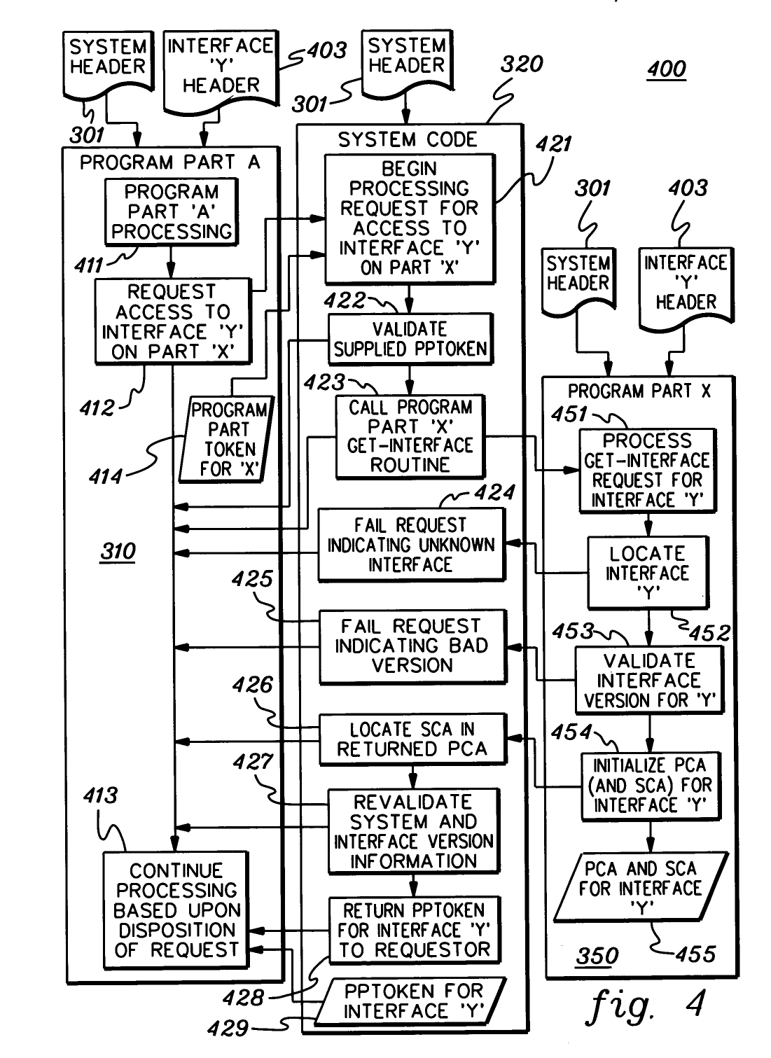

FIG. 4 illustrates a flow diagram 400 for one embodiment of a method of automatically ensuring compatibility of a requested interface of a code module for a program-code environment, wherein another code module requests access to the requested interface, in accordance with an aspect of the present invention. As illustrated in FIG. 4, Program Part A 310, system code 320, and Program Part X 350 of the program-code environment are built with system header file 301. In addition, Program Part A 310, and Program Part X 350 and have access to Interface Y header file 403 for an additional interface of Program Part X. The processing of FIG. 4 begins with Program Part A processing 411. Then, Program Part A makes a request to system code 320 to access Interface Y of Program Part X 412. Program Part A provides the program-part token for Program Part X 414 with this request.

System code 320 begins processing the request for access to Interface Y of Program Part X 421 and validates the program-part token for Program Part X 414 supplied by the requesting code module, Program Part A, 422. If the program-part token (PPTOKEN) provided by the requesting code module is not valid, then the request to access Interface Y is rejected, and control is returned to the requesting code module. However, if the program-part token for Program Part X 414 is currently valid, the system code calls the get-interface routine of Program Part X 423, passing the interface identifier, the version information specified by the requestor (requesting code module), and the address of the memory location into which the address of the PCA for Interface Y is to be stored.

In response, the get-interface routine of Program Part X 350 processes the request for access to Interface Y 451. Program Part X attempts to locate Interface Y 452. If Interface Y cannot be located, the requested interface is not supported by the program part, and the request is failed by the system code with an indication that the requested interface is unknown to the loaded version of Program Part X 424. However, if Interface Y is located, then Program Part X validates the requested interface version of Interface Y 453. If the requested version of Interface Y is not supported by the loaded version of Program Part X, the system code fails the access request, indicating a bad requested version 425. However, if requested version of Interface Y is supported, Program Part X initializes the PCA 455 for Interface Y 454 and returns a program-part token for Interface Y to system code 320. The initialization of PCA 455 includes initializing the SCA of PCA 455.

System code 320 locates the SCA in the returned PCA for Interface Y 426. The PCA for Interface Y is checked by the currently-running system code to verify that the SCA is located in the PCA compliance with the requirements of the currently-running system code version. If the returned PCA passes this check, the system code re-validates the system and interface version information in the returned PCA of Interface Y 427 to ensure that the supplied interface is consistent with Program Part A's request and compatible with the system code's capabilities. If the returned program communication area indicates that that Interface Y of the currently-loaded version of Program Part X is compatible with Program Part A and the currently-running version of the system code, the system code returns a program-part token for Interface Y 429 to the requestor (Program Part A) 428. System code 320 also returns to Program Part A if there is a verification failure in steps 422 through 427. After the system code completes the processing of Program Part A's request and returns, the Program Part A continues processing based upon the disposition of Program Part A's request to access Interface Y 413.

There is flexibility in how a code module may satisfy a request to access an additional interface of the code module. Because the code module is supplied with the required version information, the code module can take any steps necessary to satisfy the request. In one embodiment, the code module dynamically generates the requested interface.

The capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of automatically ensuring compatibility of a requested code module for a program-code environment, the method comprising:
(i) providing by a requested code module an indication of at least one compatible operating system version, the requested code module being executable by the at least one compatible operating system version; and
(ii) automatically comparing the indication to version information of a currently-running operating system of a program-code environment when the currently-running operating system loads the requested code module, wherein compatibility of the requested code module is ensured upon the automatically comparing establishing agreement between the indication and the version information of the currently-running operating system.

2. The method of claim 1, wherein the requested code module is to be loaded in the program-code environment in response to a request by a requesting code module to access the requested code module, and the method further comprises (iii) automatically comparing a code-module version requirement of the requesting code module and version information of the requested code module, wherein compatibility of the requested code module is ensured upon, additionally, the automatically comparing (iii) establishing compatibility of the code-module version requirement of the requesting code module and the version information of the requested code module.

3. The method of claim 2, wherein the requesting code module requests a particular interface version of the requested code module, and the automatically comparing (iii) further comprises determining whether the requested code module is capable of providing the particular interface version.

4. The method of claim 3, wherein the requested code module dynamically constructs the particular interface version requested by the requesting code module.

5. The method of claim 3, wherein the particular interface version is defined by a program communications area provided by the requested code module, and the method further comprises (iv) checking a validity of the program control area, wherein compatibility of the requested code module is ensured upon, additionally, the checking establishing the validity of the program communications area with respect to a format specification therefor provided by the currently-running operating system.

6. The method of claim 2, wherein the requesting code module requests a particular interface version of the requested code module; the method further comprises (v) automatically comparing a program-module version requirement of the currently-running operating system to version information of the particular interface version; and compatibility of the requested code module is ensured upon, additionally, the automatically comparing (v) establishing compatibility of the particular interface version and the currently-running operating system.

7. The method of claim 2, wherein the requested code module exports a plurality of interfaces in a program communications area provided by the requested code module; the requesting code module requests a particular interface of the plurality of interfaces exported; and the automatically comparing (iii) further comprises determining whether a currently-loaded version of the requested code module is capable of providing the particular interface.

8. A system of automatically ensuring compatibility of a requested code module for a program-code environment, the system comprising:
(i) means for providing by a requested code module an indication of at least one compatible operating system version, the requested code module being executable by the at least one compatible operating system version; and
(ii) means for automatically comparing the indication to version information of a currently-running operating system of a program-code environment when the currently-running operating system loads the requested code module, wherein compatibility of the requested code module is ensured upon the automatically comparing establishing agreement between the indication and the version information of the currently-running operating system.

9. The system of claim 8, wherein the requested code module is to be loaded in the program-code environment in response to a request by a requesting code module to access the requested code module, and the system further comprises (iii) means for automatically comparing a code-module version requirement of the requesting code module and version information of the requested code module, wherein compatibility of the requested code module is ensured upon, additionally, the means for automatically comparing (iii) establishing compatibility of the code-module version requirement of the requesting code module and the version information of the requested code module.

10. The system of claim 9, wherein the requesting code module requests a particular interface version of the requested code module, and the means for automatically comparing (iii) further comprises means for determining whether the requested code module is capable of providing the particular interface version.

11. The system of claim 10, wherein the requested code module dynamically constructs the particular interface version requested by the requesting code module.

12. The system of claim 10, wherein the particular interface version is defined by a program communications area provided by the requested code module, and the system further comprises (iv) means for checking a validity of the program control area, wherein compatibility of the requested code module is ensured upon, additionally, the means for checking establishing the validity of the program communications area with respect to a format specification therefor provided by the currently-running operating system.

13. The system of claim 9, wherein the requested code module exports a plurality of interfaces in a program communications area provided by the requested code module; the requesting code module requests a particular interface of the plurality of interfaces exported; and the means for automatically comparing (iii) further comprises means for determining whether a currently-loaded version of the requested code module is capable of providing the particular interface.

14. At least one program storage device readable by a machine embodying at least one program of instructions executable by the machine to perform a method of automatically ensuring compatibility of a requested code module for a program-code environment, the method comprising:
(i) providing by a requested code module an indication of at least one compatible operating system version, the requested code module being executable by the at least one compatible operating system version; and
(ii) automatically comparing the indication to version information of a currently-running operating system of a program-code environment when the currently-running operating system loads the requested code module, wherein compatibility of the requested code module is ensured upon the automatically comparing establishing agreement between the indication and the version information of the currently-running operating system.

15. The at least one program storage device of claim 14, wherein the requested code module is to be loaded in the program-code environment in response to a request by a requesting code module to access the requested code module, and the method further comprises (iii) automatically comparing a code-module version requirement of the requesting code module and version information of the requested code module, wherein compatibility of the requested code module is ensured upon, additionally, the automatically comparing (iii) establishing compatibility of the code-module version requirement of the requesting code module and the version information of the requested code module.

16. The at least one program storage device of claim 15, wherein the requesting code module requests a particular interface version of the requested code module, and the automatically comparing (iii) further comprises determining whether the requested code module is capable of providing the particular interface version.

17. The at least one program storage device of claim 16, wherein the requested code module dynamically constructs the particular interface version requested by the requesting code module.

18. The at least one program storage device of claim 16, wherein the particular interface version is defined by a program communications area provided by the requested code module, and the method further comprises (iv) checking a validity of the program control area, wherein compatibility of the requested code module is ensured upon, additionally, the checking establishing the validity of the program communications area with respect to a format specification therefor provided by the currently-running operating system.

19. The at least one program storage device of claim 15, wherein the requesting code module requests a particular interface version of the requested code module; the method further comprises (v) automatically comparing a program-module version requirement of the currently-running operating system to version information of the particular interface version; and compatibility of the requested code module is ensured upon, additionally, the automatically comparing (v) establishing compatibility of the particular interface version and the currently-running operating system.

20. The at least one program storage device of claim 15, wherein the requested code module exports a plurality of interfaces in a program communications area provided by the requested code module; the requesting code module requests a particular interface of the plurality of interfaces exported; and the automatically comparing (iii) further comprises determining whether a currently-loaded version of the requested code module is capable of providing the particular interface.
